(19) United States
(12) Patent Application Publication
(10) Pub. No.: US 2018/0027804 A1
(43) Pub. Date: Feb. 1, 2018

(54) PARTICLE BASED ENHANCED REMOVAL FOR DISINFECTION OF SURFACES

(71) Applicants: University of Florida Research Foundation, Inc., Gainesville, FL (US); Unilever, Trumbull, CT (US)

(72) Inventors: Brij M. Moudgil, Gainesville, FL (US); Vignesh Nandakumar, Gainesville, FL (US); K.P. Ananthapadmanabhan, Trumbull, CT (US); Prem Chandar, Trumbull, CT (US); Guohui Wu, Trumbull, CT (US)

(21) Appl. No.: 15/665,977

(22) Filed: Aug. 1, 2017

Related U.S. Application Data
(60) Provisional application No. 62/369,398, filed on Aug. 1, 2016.
(60) Provisional application No. 62/369,410, filed on Aug. 1, 2016.
(60) Provisional application No. 62/369,431, filed on Aug. 1, 2016.

(51) Int. Cl. A01N 25/08; A01N 27/00; A01N 33/04

(52) U.S. Cl. CPC A01N 25/08; A01N 33/04; A01N 27/00

(57) ABSTRACT

A suspension for removing microbes from a surface comprises contacting a plurality of modified particles (MPs), comprise a plurality of microparticles are coated by one or more polymers or their surfaces are covalently bonded to functionality that promotes a cationic surface. The microparticles can be a metal, metal oxide, an organic particle, or any other microparticle. A metal oxide microparticle can be functionalized by a silane coupling agent or the organic microparticle can be a polymer or copolymer that has a functionalized monomer or polymer covalently or ionically bonded to a particle. The coating can be a polymer such as polyethylene imine or chitosan. The surface can be contacted by washing with the suspension of the modified microparticles.

### CROSS-REFERENCE TO RELATED APPLICATIONS

This application claims the benefit of U.S. Provisional Application Ser. No. 62/369,398, filed Aug. 1, 2016, U.S. Provisional Application Ser. No. 62/369,410, filed Aug. 1, 2016, and U.S. Provisional Application Ser. No. 62/369,431, filed Aug. 1, 2016, the disclosures of which are hereby incorporated by reference in their entireties, including all figures, tables and drawings.

This invention was made with Government support under IIP-1362060 awarded by the National Science Foundation. The Government has certain rights in this invention.

### BACKGROUND OF INVENTION

Microbial resistance to antibiotics and antimicrobial materials, including antimicrobial peptides and silver, has caused concern for the last decade and has reached a tipping point with a number of pathogens declared at threat levels considered to be urgent. Nosocomial infections, with high levels of antibiotic resistances are often transferred to people primarily via contact. While several approaches including antimicrobial surface coatings, cleaning substrates with antimicrobial agents, such as bleach, have been used to disinfect pathogens on surfaces, proper hand hygiene and skin disinfection still remains the most practical disinfection method. A disinfectant is defined as an agent that frees from infection; usually a chemical agent that destroys disease germs or other harmful microorganisms or inactivates viruses. Significant efforts have been devoted to the discovery of novel antimicrobial chemicals, materials and other alternate strategies for infection prevention, most methods involve microbial inactivation by killing. Such kill based approaches are often necessary for dangerous pathogens, however excessive use of primarily kill based approaches drive the cycle of antimicrobial resistance.

The conventional approach for disinfection of surfaces or suspensions involves the use of biocides that primarily focus on kill. Sanitization is defined as reducing the number of live microorganisms on a surface. Hand hygiene and skin disinfection are a subset of surface disinfection with defined set of boundary conditions that include very short exposure times and limits imposed by cytotoxicity and biocompatibility of disinfecting agents. The use of antimicrobial soaps and hand wash agents to reduce microbial counts to levels that significantly reduce the odds of infection transfer fall short of hand hygiene targets due to: the inability of antimicrobial actives to kill resistant spores, viruses or fungi; the rate of kill required in hand wash systems; and the inability to reach microbes that are adsorbed in hard to access regions, such as crevices and small pores. It is questionable that antibacterial soaps perform better than regular soaps. Recently, the FDA banned 17 antimicrobial actives used in antimicrobial soaps and emphasized the reduction of excessive use of common antimicrobial actives like triclosan and triclocarban, which is indicative of its concern on the issue of potential antimicrobial approaches that primarily rely on microbial kill. Therefore, development of alternative approaches that focus on removal rather than killing of microbes is urgent. To this end novel disinfection approaches, including desiccation, photocatalysis and physical puncturing, have been examined as alternatives to chemicals currently used for disinfection.

Alternate approaches, that indirectly address sanitization, aim at preventing the adsorption of microbes on the surfaces via chemical and physical patterning. There are, however, situations that demand not just killing of the microbes but also removal of the toxins that remain as residues on surfaces. Bacterial and fungal spores are extremely resistant to kill using common disinfectants, and are often left behind after the use of sanitizers. Typically, spores are usually extremely resistant to sanitizers and can cause severe, sometimes fatal, allergies in people, depending on the type of spore exposure. Other examples which necessitate removal as oppose to killing involve removal of dead skin cells, pet dander and other allergen causing antigens. To this end effective removal of microbes, with or without kill is a desirable mode or disinfection. Removal based approaches have primarily employed the use of surfactants for microbial wash off and have had limited success due to temporal limitations involved for handwashing. A novel approach to disinfection must address particle adhesion and stripping based microbial removal. A particle approach has the potential for implementation in suspensions and on surfaces.

### SUMMARY OF THE INVENTION

Embodiments of the invention are directed to suspensions for removing or repelling microbes from a surface where the suspension includes modified particles (MPs) that comprise microparticles or nanoparticles of metals, alloys, metal oxides, graphite, organic polymer, ceramic, or any combination thereof, upon the particles surfaces has been formed a coating or the particles surface has been covalently bonded a functionality, and with the MPs suspended in a liquid for removal or for deposition of a repelling coating. The MPs can be coated or surface reacted metals, alloys, metal oxides or any combination thereof. The MPs can be coated or surface reacted organic particles. The coating can include a cationic polymer, an anionic polymer, or a nonionic polymer. The covalently bound functionality can be a surface reacted product from aminopropyltriethoxy silane or other amino comprising silane or a surface grafted cationic polymer. The coating can include a pluronic. The liquid for suspending the MPs can be an aqueous solution and can include a surfactant. In embodiments of the invention, the MPs are formed from silica microparticles and/or polystyrene microparticles with a coating of polyethylene imine (PEI) or chitosan.

Embodiments of the invention are directed to a method of removing microbes from a surface where a suspension of MPs, having a positive Zeta potential greater than the positive Zeta potential of the surface, are used to associate with the microbes upon contact of the suspension and the surface. Another embodiment of the invention is directed to a method of repelling microbes from a surface where a suspension of MPs is contacted with a surface to provide an anionic surface having a negative Zeta potential greater than the negative Zeta potential of the microbe.

### BRIEF DESCRIPTION OF DRAWINGS

FIG. 1 shows a representation of charged, cationic particles associating with dirt or bacteria on a substrate and removal by the associated pair, according to an embodiment of the invention.

FIG. 2 shows a bar chart for bacterial removal from DI water in 180 seconds where Silica PEI (SP) and Silica chitosan (Sch) groups show 98% and 84% removal as compared to control silica which shows only 10%, according to embodiments of the invention.

FIG. 3 shows a bar chart for bacterial removal from Tween 80 in 180 seconds where SP and Sch groups show 89% and 63% removal as compared to control silica (SC) which shows only 25%, according to embodiments of the invention.

FIG. 4 shows a fluorescence microscopic image of SPs showing significant attachment of bacteria to the surface of the particle (PEI—system), according to embodiments of the invention.

FIG. 5 shows a fluorescence microscopic image of SC particles showing no significant bacterial attachment.

FIG. 6 shows a fluorescence microscopic image of PPs showing significant attachment of bacteria to the surface of the particle without inducing kill as indicated by green fluorescence—(Polydopamine system), according to embodiments of the invention.

FIG. 7 shows a fluorescence microscopic image of control polymer particles (PC) showing no significant bacterial attachment.

FIG. 8 shows a bar chart of E. coli recovery from suspension following interaction with SP10 and SC10, according to embodiments of the invention.

FIG. 9 shows fluorescence microscopy images of particles recovered following centrifugation with SP10, according to an embodiment of the invention.

FIG. 10 shows fluorescence microscopy images of particles recovered following centrifugation with SC10.

FIG. 11 shows a bar chart for the removal of bacteria from a plastic substrate in 30 seconds using SP10, SP40, aminated 40 μm silica, SC10, and SC40; where the best performing was for SP10, according to embodiments of the invention.

FIG. 12 shows electron microscopy images of artificial skin washed with a SP suspension, a SC suspension, a Tween 80 solution, and a commercial non antibacterial soap, showing the superiority of bacteria removal with the SP suspension, according to an embodiment of the invention.

FIG. 13 shows a bar chart for the effect of particle charge for removal of bacteria from artificial skin, according to an embodiment of the invention.

FIG. 14 shows a bar chart expressing the impact of particle mass and number density on interaction and removal of E. coli from artificial skin, according to an embodiment of the invention.

FIG. 15 shows a bar chart for the effect of particle concentration on the removal of bacteria from artificial skin, according to an embodiment of the invention.

FIG. 16 is a plot of the bacteria reduction from artificial skin as a function of particle velocity for SP10, SC10, Tween 80 and a water control, according to an embodiment of the invention.

FIG. 17 shows a bar chart of the effect of pH on the effectiveness of SP10 at various pH relative to SC10, according to an embodiment of the invention.

FIG. 18 shows a bar chart of the effect of SC10 and SP10 following multiple washes with SC10 particles.

FIG. 19 shows a bar chart that indicates selective flocculation of E. coli over Staph aureus in a mixed culture system where cationic SPs display specificity towards different cells based on the charge and charged moieties exhibited by the cells.

FIG. 20 shows a bar chart of bacteria viability for the bacteria in the presence of different concentration of SPs, where kill does not occur on 30 second contact for either E. coli or staph aureus.

FIG. 21 shows a bar chart indicating selectivity in disinfection of E. coli over S. aureus, according to an embodiment of the invention.

### DETAILED DISCLOSURE

Embodiments of the invention are directed to disinfection by engineered fine particles that bind and strip microbes from surfaces. For example, in one embodiment of the invention, silica particles are modified with cationic polymers for provide interaction with bacterial cells for enhanced interaction and removal of bacteria via particle enabled stripping. These modified particles (MPs) enhance removal of microbes from surfaces, kill or recover these microbes for further investigation. In another embodiment of the invention, particles are functionalized to prevent microbial adhesion and modify various surfaces by their deposited on the surfaces.

MPs, either of micro and/or nano dimensions, enable enhanced removal with or without kill of microbes from surfaces and suspension when modified. The MPs can be formed from organic, inorganic, or metal particles that are modified with polyamine or cationic polymers via physical adsorption due to charge and/or Vander walls interactions for removal of microbes from surfaces. The particles can be modified with a mixture of quaternary ammoniums and cationic polymers for removal and kill of target microbes. Particles can be modified with anionic and nonionic polymers (pluronics) for repelling/preventing microbial deposition and colonization on surfaces. The particles can be modified covalently with silane chemistry to yield cationic, hydrophobic, specific functional groups to target, remove and kill microbes. Particles can be covalently functionalized with antibodies for targeting microbes with specificity. A mixture of different functionalized particles can be formed to achieve one or more objective.

The particles can be inorganic or organic. Inorganic particles can be, but are not limited to, metals, alloys, or metal oxides. Metals can be any non-toxic metal that is a stable solid in air or water. Metal oxides can be, but are not limited to, aluminum oxide, barium oxide, calcium oxide, cerium oxides, chromium oxides, cobalt oxides, copper oxides, gallium oxides, germanium oxides, iron oxides, lead oxides, magnesium oxide, manganese oxides, molybdenum oxides, nickel oxides, ruthenium oxides, silicon oxide, silver oxide, tin oxides, titanium oxides, tungsten oxides, and zinc oxide. Graphite particles can be graphite, fullerenes, carbon nanotubes, or any other carbon particle. Organic particles can be natural or synthetic polymers, copolymers, gels, or resins. Polymers can be a synthetic polymer or copolymer, including, but is not limited to polyethylene, polypropylene, polybutylene, polystyrene, polyvinyl chloride, any polyamide, any polyurethane, any polyester, any polyimide, polyethersulfone, polycarbonate, any polyacrylate, any polymethacrylate, polybutadiene, polyvinylmethylether, polytetrafluoroethylene, polyisoprene, polyacrylonitrile, polyethyleneterephthalate, polyacetal, polybutyleneterephthalate, polyetheretherketone, polyamideimide, polyetherimide, thermoset silicone, or acrylonitrile-butadiene-styrene. The polymer can be a natural polymer or derived from a natural polymer, such as cellulose or chitin. The polymer particles can be surface modified to be covalently grafted or physically bound to a monomeric, oligomeric, or polymeric modifying agent.

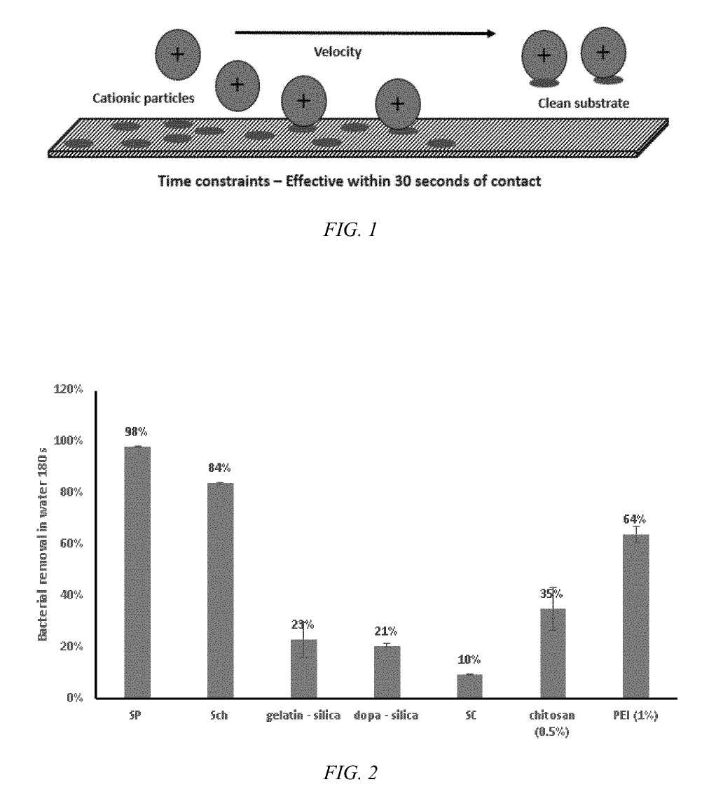

For example, the particles can be coated with branched polyethyleneimine (bPEI) to impart high charge density. Any chemical modification including amines and cationic charge can function in the manner illustrated in FIG. 1. Other cationic polymers, those with an inherent positive charge on repeating units of the polymer or are readily protonated in neutral or acidic water solutions, may be used, including, but not limited to, PEI, 2-(dimethylamino)ethyl methacrylate (DMAEMA), poly(amidoamine) (PAMAM), Bufloc 535, Nalco 7607, Reten 201, Cypro 515, Bufloc 5554, Busperse 5030, cationic polymers, inorganic cationic species, biological cationic polymers, modified chitosan, cationic liposomes, polyacrylamides, dicyandiamideformaldehyde, diallydimethylammonium chloride, octadecyldimethoxylsilpropyl-ammonium chloride, epichlorohydrinamine, octadecyldimethyltrimethoxylsilpropylammonium chloride, modified starch, 1-methyl-2-Noroleyl-3-oleyl-amidoethylimidazoline methylsulfate, 1-ethyl-2-Noroleyl-3-oleyl-amidoethylimidazoline ethylsulfate, trimethylsilylmodimethicone, amodimethicone, polyquaternium-2, polyquaternium-4, polyquaternium-5, polyquaternium-7, polyquaternium-, polyquaternium-9, polyquaternium-10, polyquaternium-11, polyquaternium-12, polyquaternium-13, polyquaternium-14, polyquaternium-15, polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-32, polyquaternium-33, polyquaternium-34, polyquaternium-35, polyquaternium-36, polyquaternium-37, polyquaternium-39, polysilicone-1, polysilicone-2, and mixtures and combinations thereof. Metal oxide particles can be treated with silane coupling agents such as aminopropyltriethoxy silane or other amino silanes to prepare silica or other metal oxide particles that can have an effective positive charge upon amine protonation by any acid in the water or by the microbes to be removed. Disinfectant particles that remove, with or without killing, of microbes from surfaces and suspension are those modified by one of more cationic polymers or a mixture of silanes with addition/condensation enabling groups. The particle can be modified with polymers of various charges, hydrophobicity, carboxylic acid, ester, or epoxide content that can be rendered ionic upon a subsequent reaction to form a covalent bond or upon carrying out an acid-base reaction to protonate, in the case of a cationic polymer, or deprotonate, in the case of an anionic polymer. The modified particles attract microbes and trap them on their surface in very short periods of time by columbic and hydrophobic interactions as the primary mode of action.

Particle based enhanced removal technology (PERT) microparticles can be used a stand alone non-toxic, and skin safe product for skin sanitization via microbial removal (current products are focused on kill, therefore having cationic components that cause skin irritation and dehydration). The MPs, according to an embodiment of the invention, can be used for the removal of spores and viruses from skin; thereby decontaminating skin to a degree better than ever before (inactivation or killing of spores using commercially available hand wash agents has been a difficult challenge to overcome). The MPs can be used in synergy with currently available hand washes to enhance the efficacy of hand sanitization. Paper towels using the modified microparticles as fillers can be used to further improve residual microbes on hand after hand washes.

MPs can enhance the efficacy of “cleaning in place” for complete removal of microbial contaminants. MPs embedded in fabric can be used to clean surfaces for removal of toxins spores and other microbes. MPs enhance the cleaning and removal of microbes from fabrics to enhance the efficacy of disinfection, for example, removing pathogens from hospital sheets and clothing. Particles modified with anionic and non-ionic polymers can be impregnated in fabrics via electrophoretic deposition to repel microbial adsorption on surfaces. MPs suspensions can be used to trap mold spores, cat/dog dander and other allergens which can not be killed. MPs can be embedded in fabrics of chairs and other devices to bind molds and spores to prevent their re-dispersion in air and further be removed using detergents to prevent allergies. The detergents can re populate unbound MPs to the devices.

Removal of microorganisms from surfaces results in sanitization of the surface. MPs functionalized by physically adsorbing different polymers can bind to and remove microorganisms from a surface or even kill based on the functionalization of choice. For spores and viruses, where disinfection via kill is a huge challenge, binding and removal from surfaces is a quick and easy method to disinfect surfaces. Common allergens including mold spores and pollen can also be adsorbed onto the particles for recovery and removal.

MPs can be used a standalone non-toxic, and skin safe product for skin sanitization via microbial removal as an alternative to current products focused on microbe kill. MPs can be used for the removal of spores and viruses from skin; thereby decontaminating skin to a degree better than ever before. MPs can be used in synergy with currently commercially available hand washes to enhance the efficacy of hand sanitization. Paper towels with MPs can further remove residual microbes on hands after hand washing. Dental hygiene can be enhanced by using MPs for removal of microbes from teeth and tongue.

Removal of microorganisms from surfaces results in sanitization of the surface. Microparticles including but not limited to silica and polystyrene can be functionalized by physically adsorbing different polymers yielding modified particles (MPs) that can bind to and remove microorganisms from a surface or even kill based on the functionalization of choice. For spores and viruses, where disinfection via kill is a huge challenge, binding and removal from surfaces is a quick and easy method to disinfect surfaces. Common allergens including mold spores and pollen can also be adsorbed onto the particles for recovery and removal.

In an embodiment of the invention, MPs functionalized with pluronics with varying degrees of amphiphilic properties/anionic and a consortium of anti-adhesion polymers can be deposited or covalently bound to substrates to prevent bacterial settling and colonization. Patterns of MPs of various modifications can be constructed to provide chemical and physical topographies to combat biofouling issues. In an embodiment of the invention, MPs functionalized with antibodies can be used for entrapment, isolation and removal of microbes and further be recovered for investigation. MPs bound to microbes can be used for potential bio-sensing applications.

In an embodiment of the invention, Cationic MPs allow non-specific removal and recovery of bacteria. For example, but not limited to, modification of Silica particles with branched polyethyleneimine, chitosan, or polyacrylamides where the quantity of charge can be controlled.

In an embodiment of the invention, Cationic MPs can be prepared for non-specific kill and removal of bacteria. For example, but not limited to, silver and/or tin speckled silica microparticles modified with a mixture of quaternary ammonium polymers like Merquat or other quaternary ammonium polymers can be prepared.

In an embodiment of the invention, silane modified silica/metal oxide particles permit a varying degrees of hydrophobicity and cationic functionalities can be incorporated onto silica particles via condensation polymerization to have covalently bound functional groups from one or more silane coupling agents, some of which are listed below, that can bind, kill or repel microbes.

In an embodiment of the invention, Cationic MPs allow for adhesion and kill of microbes. In contrast, according to embodiment of the invention, MPs formed by a C₄-C₂₄ short to long chain alkyl comprising silane, for example, but not limited to, trimethoxy(octadecyl)silane functionalization allow formation of hydrophobic silica particles for adhesion to microbes. Also, in an embodiment of the invention, 2-methoxy polyethyleneoxypropyltrimethoxysilane or other polyether silane coupling agents can be used to form MPs that are microbe repelling silica particles for deposition onto surfaces to create anti-biofouling surfaces.

In an embodiment of the invention, cationic MPs with graftable functionalizations can be used for removal and kill of microbes. For example, but not limited to, MPs form silica particles reacted with 3-aminopropyltrimethoxysilane and any one or more of: (3-Mercaptopropyl)trimethoxysilane; 3-Glycidyloxypropyltrimethoxysilane; 3-(2-Aminoethyl-amino)propyldimethoxymethylsilane and 3-(Trimethoxysilyl)propyl Acrylate.

Significant disinfection of skin of greater than 4 log bacterial reduction can be achieved by enhanced bacterial removal as opposed to the current practiced kill based approaches. By engineering particles having strong interactions with bacteria permits an additional 2.5 log reduction in microbial removal over unfunctionalized particles. Strong bacteria-particle interactions were found to be capable of breaking bacteria substrate interaction. By controlling the zeta potential difference between the particle and bacteria to about 15 mV over the zeta potential difference between the bacteria and the substrate was discovered to be approximately optimal. Particle mass was found to play an important role to impart sufficient momentum to the particle-bacteria ensemble such that the particle could peel bacteria from the substrate. To impart sufficient momentum for a fixed set of particles a critical particle velocity is required, and is readily achieved. Particle number density plays a critical role for efficient interaction and efficacious bacterial removal. For example, Cationic SPs of +35 mV employed with bacteria with a zeta potential of −40 mV, using a particle size of 10 μm at a concentration of 10⁵-10⁶ particles per 10⁷ bacteria cells and a particle velocity of about 1500 rpm vortex speed in 0.5% Tween 80 results in a 2.5 log reduction in the bacterial removal was achieved over the control experiments.

### Methods and Materials

### MP Preparation and Characterization

Silica particles, 200 mg, were washed with water, ethanol water triple treatment to remove any impurities on the surface of the particles. A 2 wt % PEI solution was prepared by dissolving 2 g of PEI (Mₙ=10000) in 100 ml of water. 10 ml of 2 wt % PEI with was added to 200 mg of silica particles and stirred for 14 hours. The particles were then washed with DI water four times and stored in 10 ml of water for use. Polystyrene particles were modified the same manner. Functionalized silica particles were called (SP) and polystyrene particles were called (PP)

Silica microparticles (1 g) were etched with 1M HCl and washed thrice to hydroxylate the silica surface and remove any organic contaminants. Subsequently, PEI was adsorbed onto the particles with 40 ml of 2 wt % PEI (10 kDa) at pH 10.5 in a rotisserie. The SPEI MPs were harvested via centrifugation at 10000 rpm (9000-17000 g) for 30 minutes and washed thrice with deionized (DI) water to remove any loosely adsorbed PEI followed by lyophilization using a Labonco freeze drier overnight. Particle suspensions were prepared using 1 wt % of modified (SP or PP) or unmodified particles (SC or PC) in 0.5% Tween 80 unless otherwise noted.

PEI loading on SP MPs was assessed using elemental analysis on a Carlo Erba NA1500 CNHS elemental analyzer. Samples were flash combusted in a quartz column containing chromium oxide and silvered cobaltous/cobaltic oxide at 1020° C. in an oxygen rich atmosphere. Subsequently, the sample gas was transported in a He carrier system and passed through a hot copper reduction column at 650° C. to remove oxygen and a chemical trap to remove water. The gas stream was passed through a gas chromatography column to separate N₂ and CO₂ and was quantified via a thermal conductivity detector measuring the size of the pulses of respective gases.

A 1% chitosan solution was prepared by dissolving chitosan in 0.2M acetic acid and stirred overnight. 10 ml of 1% chitosan with was added to 200 mg of silica particles and stirred over night for 14 hours. The particles were then washed with DI water 4-5 times and stored in 10 ml of water for use. Chitosan modified MPs are labeled Sch and Pch for silica and polystyrene, respectively.

### Particle Characterization

SPs and unmodified SC particles were characterized for zeta potential values using Brookhaven ZetaPlus, and their particle size was measured using Coulter LS13320. Zeta potential measurements were performed at 10 mM KCl and pH 8.0-8.5 that was adjusted using 10 mM NaOH or 10 mM HCl as necessary. SPs were also analyzed using a Zeta Reader and recorded in 10 mM NaCl at a pH of 6.2 or 7.0.

All particles except 200 nm fines were collected upon settling of coarser fractions over 30 minutes and were considered to be representative of the sample. Collected fines were used for zeta potential measurements. Particle sizing of microparticles was also performed using imaging techniques using RapidVUE or Image J.

### Substrate Preparation and Characterization

VITRO-SKIN®, a commercially available artificial skin substrate coated with collagen, gelatin and silica particles to mimic physicochemical properties of natural human skin including pH, topography, and ionic strength, was prepared for the experiment as suggested by the manufacturer by hydrating a 1.5 cm×1.5 cm patch, overnight, using a glycerol:water (15:85) binary mixture in a humidity chamber. Surface potential of VITRO-SKIN® was measured (Paar Physica Electro Kinetic Analyzer) at 10 mM KCl and pH 6.7. Additionally, contact angle measurements with water, glycerol, ethylene glycol and diiodomethane were carried out using the sessile drop method within 60 s of deposition, and were used to estimate the critical surface energy of the artificial skin substrate using the Zisman plot method.

### Bacterial Growth and Characterization

E. coli was grown in Trypticase Soy Broth to a log phase OD₆₀₀ of 0.3 at 37 C and 120 rpm. The bacteria was harvested by centrifugation at 2500*g at 4 C and 15 mins. The OD₆₀₀ was adjusted to 0.5 in DI water and stored till use.

Another E. coli strain employed in this study (ATCC 25923 GFP) was characterized for surface energy using a light scattering technique. Briefly, E. coli cells at set a concentration were suspended in ethanol:water binary mixture at varying surface tensions and vortexed for 30 seconds at 1500 rpm before leaving them undisturbed for 20 min. The samples were then centrifuged at 722 g for 45 seconds and measured for optical density at 600 nm. Suspension with the highest optical density provided the greatest stability to cells and, therefore, determined to be closest to the cell surface energy values. Microbial adhesions to solvents (MATS) assays were used to investigate bacterial cell surface properties including hydrophobic components, and electron donor groups. For the MATS assay, 2.4 ml of thoroughly rinsed bacterial cells suspended in 100 mM KNO₃ were vortexed at 1500 rpm for 90 seconds with 0.4 ml of chloroform and hexadecane and left undisturbed for 20 minutes. Adhesion to solvents was estimated by the following equation:

% adherence=100(1−A/A₀)

where A₀ is the optical density at 600 nm of the aqueous suspension before mixing and A is the optical density of the aqueous suspension after mixing with the solvent pair.
Bacterial Adsorption on Particle and Removal from Media

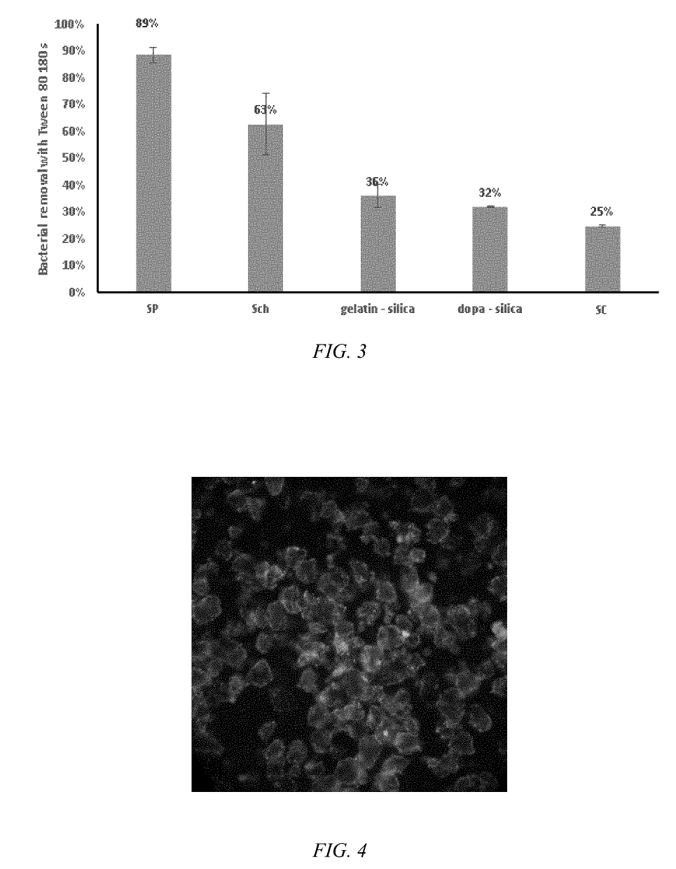

MPs PP, Pch, SP, Sch, other MPs, control polystyrene (PC), and control silica (SC) were exposed to a 1:1 ratio of OD₆₀₀ 0.5 E. coli. The particles were contacted for 3 minutes with low speed vortex at the end of every minute. The particles were then separated by low speed centrifugation 1000 g for 45 seconds. The supernatants were collected and analyzed for fluorescence in a 96 well plate with the addition of 1:1 Backlight live dead stain and stored in the dark for 15 minutes. The pellets were suspended in 100 μl water and stained with Backlight live dead stain and stored in the dark for 15 minutes. The samples were then loaded onto a glass slide for further analysis. FIGS. 2 and 3 give results for bacteria removal from water without and with tween, respectively. Similar experiments were performed with 1% tween 80 (T80) comprising MPs to show efficacy in non-ionic surfactant systems.

Bacterial Removal from a Substrate

Bacterial removal from a substrate was assessed by using a modified Shanghai Vitroskin protocol, where 10 μl of E. coli (10⁹ cells/ml) was inoculated on 1 cm² of VITRO-SKIN®, and spread carefully around the center. The substrates were then left to air dry at room temperature for 30 mins. The substrates were exposed to 0.5 wt % SPEI, SC in T80 and control suspensions of T80, PEI in a 2-ml polypropylene microfuge tube and vortexed for 30 sec. in a microfuge at 1800 rpm with a 1 s pulse. The substrates were washed by a short spin for 10 seconds in DI water followed by vortexing at 3300 rpm or 3000 rpm for 30 s in neutralization broth to remove all remaining bacteria bound to the substrate. Remnant bacteria were enumerated to assess disinfection potential of particle suspensions and compared to washing with just water. Bacteria were enumerated in Tryptic Soy Agar (TSA) following 24 hours of incubation at 37° C. Removal efficacy, as indicated in FIG. 4, which was significant only for SP treatment, was expressed as log 10 bacterial removal using the following formula.

log₁₀bacterial removal=log₁₀innoculum on skin−log₁₀bacteria remaining on skin

Kill and flocculation assays were performed similarly as detailed above without the artificial skin substrate. A 10 μl quantity of the bacterial suspension was directly treated with suspensions of modified and unmodified particles and neutralized following vortexing and dilution with D/E broth. Additionally, to assess the extent of particle-bacteria interaction, bacteria-particle agglomerates were removed via mild centrifugation at 722 g for 45 s, and the unbound cell density in the suspension was determined via the plate count method. Results were expressed in terms of total number of bacteria recovered in CFU.

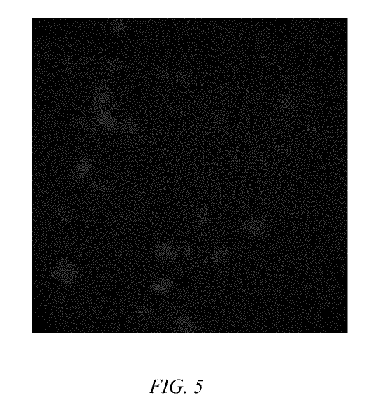

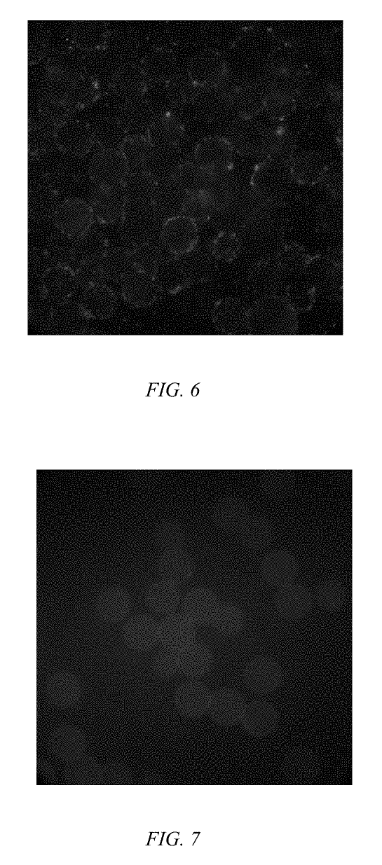

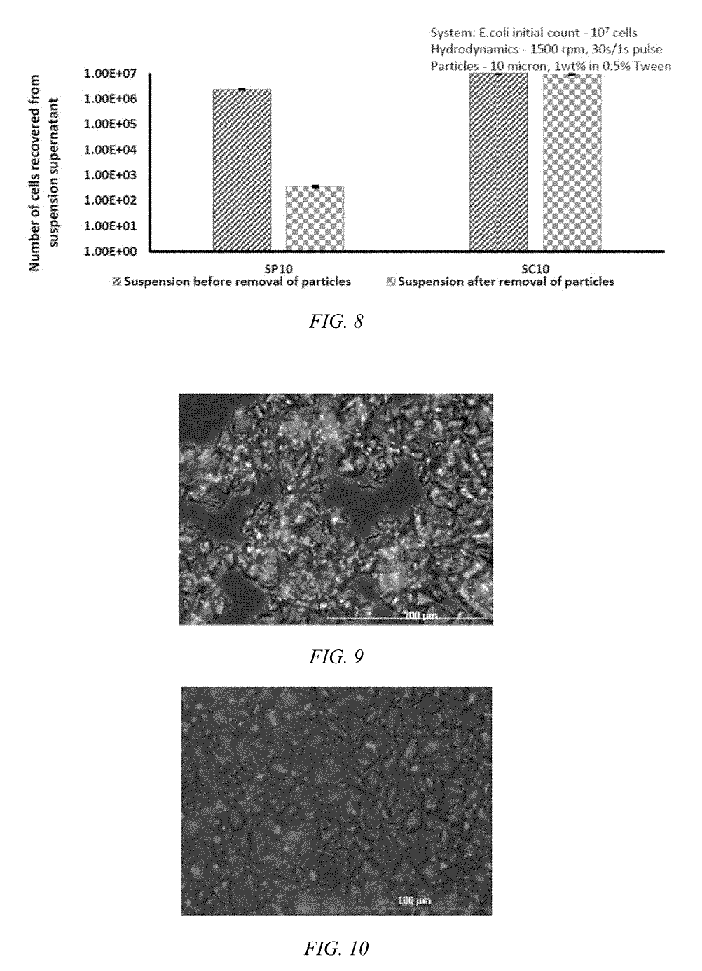

E. coli aggregates were isolated and imaged using a wide field fluorescence microscope (Cytation 5) to assess membrane damage and cell viability. For this purpose, particles and bacteria were incubated in Baclight™ LIVE/DEAD® stain and imaged under green and red filters. Bacteria with green fluorescence indicated cells without cell membrane damage and bacteria with significantly increased red fluorescence indicated bacteria with significant membrane damage and possible loss of cell viability, as shown in FIGS. 5-8.

### Microbial Enumeration

GFP E. coli enumeration was performed in Trypticase Soy Agar (TSA) with 100 mcg ampicillin. The colonies were grown in an incubator at 37 C for 24 hours before counting the colonies per plate.

### Fluorescence Spectroscopy

The supernatant collected after treatment with different particle systems were mixed with Baclight live dead stain and stored in the dark for 15 minutes. Increasing concentrations of bacteria (0.1 to 0.5 OD) was also assayed to establish the linear regime for fluorescence signals. The supernatants were compared for green and red fluorescence to quantify the amount of bacteria removed from system.

### Fluorescence Microscopy

Samples were loaded onto glass slides and covered with a 0.16 mm cover slip. Fluorescence microscopy images were acquired under the Texas red and the FITC filters.

### Particle Characterization

As indicated above, PEI adsorption on silica particles to form MPs was estimated via elemental analysis. MPs following functionalization and centrifugation were recovered and lyophilized for analysis. Particles were then characterized for size, zeta potential and PEI adsorption density, PEI loading on the particles for all particle sizes and varied between 0.1-0.9 mg/m2 particles. Zeta potential was measured for all particle sizes (10 mM KCl and pH 8.1-8.5). Results are summarized in Tables 1 and 2, below.

### Particle Sizing

The particle sizing was performed using Image J analysis of microscopic images. The average particle size was determined as 41.8+/−20.7 microns for the polystyrene particles. Silica particles averaged 37.3+/−7.28 urn for PEI modified and 54.7+/−11.5 μm for the unmodified particles.

TABLE 1
Zeta potential of microparticles and bacteria
for flocculation at near neutral pH

| Microparticles | Zeta Potentials in 10 mM NaCl |
|---|---|
| Polystyrene control | −48.43 +/− 2.48 (pH 6.2) |
| PPEI | +26.30 +/− 1.65 (pH 6.2) |
| Silica Control | −38.64 +/− 2.80 (pH 7.0) |
| SPEI | +37.75 +/− 4.77 (pH 7.0) |
| E. coli | −37.77 +/− 0.81 (pH 6.2) |

TABLE 2
Particle size, zeta potential and adsorbed polymer characterization

| Microparticle | Size (μm) | Zeta potential^{a} | Surface area^{b} | PEI adsorption |
|---|---|---|---|---|
| 200 nm SPEI (SP 0.2) | 0.218 +/− 0.039 | 36.38 +/− 2.29 | 14.6* | 8.90E−04 |
| 600 nm SPEI (SP 0.6) | 0.686 +/− 0.132 | 35.73 +/− 1.44 | 900-1100 | 1.32E−04 |
| 2 μm SPEI (SP2) | 2.191 +/− 0.488 | 37.82 +/− 0.71 | 400 | 3.26E−04 |
| 10 μm SPEI (SP10) | 13.36 +/− 6.082 | 36.35 +/− 0.95 | 475 | 3.02E−04 |
| 50 μm SPEI (SP50) | 52.81 +/− 19.90 | 32.21 +/− 0.27 | 480 | 2.85E−04 |
| 200 μm SPEI (SP200) | 207.3 +/− 78.85 | 31.12 +/− 1.05 | 480 | 2.80E−04 |
| 10 μm silica (SC10) | 13.36 +/− 6.082 | −33.53 +/− 0.56 | 475 | N/A |

^{a}10 mM KCl, pH 8.1-8.5 in mV,
^{b}Total of particles in m²/g as provided by the supplier,
^{c}adsorption in g/m²

Surface energy, and zeta potential of bacteria and artificial skin substrates are given Table 3, below. Results from MATS assay show strong interactions of the E. coli strain with a weak acidic polar solvent (chloroform: 12.5+/−2.5% adhesion) when compared to interactions with a non-polar solvent with similar Lifshitz-van der Waals component (hexadecane: 2.8+/−0.5%) indicating relatively hydrophilic nature of the strain with a base like behavior. Similar conclusions are also derived from measured surface energy values E. coli of 47.5 mJ/m² and a zeta potential of −40.33 mV. The substrate was characterized for surface energy via contact angle measurements with multiple probe liquids and was estimated to be ˜37.5 mJ/m² using the Zisman theory. Streaming potential of the substrate indicated a positive zeta potential at 10 mM KCl and pH 6.7 and is similar to that of human skin.

TABLE 3
Surface energies of bacteria and artificial skin substrate

| | Surface energy | |
|---|---|---|
| | (mJ/m²) | Zeta potential (10 mM KCl) |
| E. coli (ATCC 25922-GFP) | 47.5 +/− 1.5 | −40.33 +/− 1.46 (pH 8.1) |
| Vitro-Skin ® | 37.5 | +22.5 +/− 0.7 (pH 6.7) |

### Particle-Bacteria Interactions

The degree of interaction between various particles modified to differing degrees and unmodified particles with bacteria was assessed by mixing particles with a microbial suspension at a concentration of 10⁷ cells followed by centrifugation and microbial enumeration to quantify bacteria-particle interaction and differentiate between removal and kill based reduction in microbial counts. The 10 μm modified silica particles (SP10) and unmodified particles (SC10) were investigated with E. coli and are plotted in FIG. 9. E. coli particle removal following bacteria particle interactions via low speed centrifugation was found to result in significantly reduced amounts of free bacteria in supernatant (4.4 log reduction) indicating strong Coulombic interactions of bacteria with oppositely charged SP10 particles with minimal kill. It was also noted that a 10-fold increase in bacterial concentration for fixed particle concentration of 1 wt. % resulted in visible flocculation of the particle suspension further indicating strong bacteria-particle interactions in the suspension (data not shown).

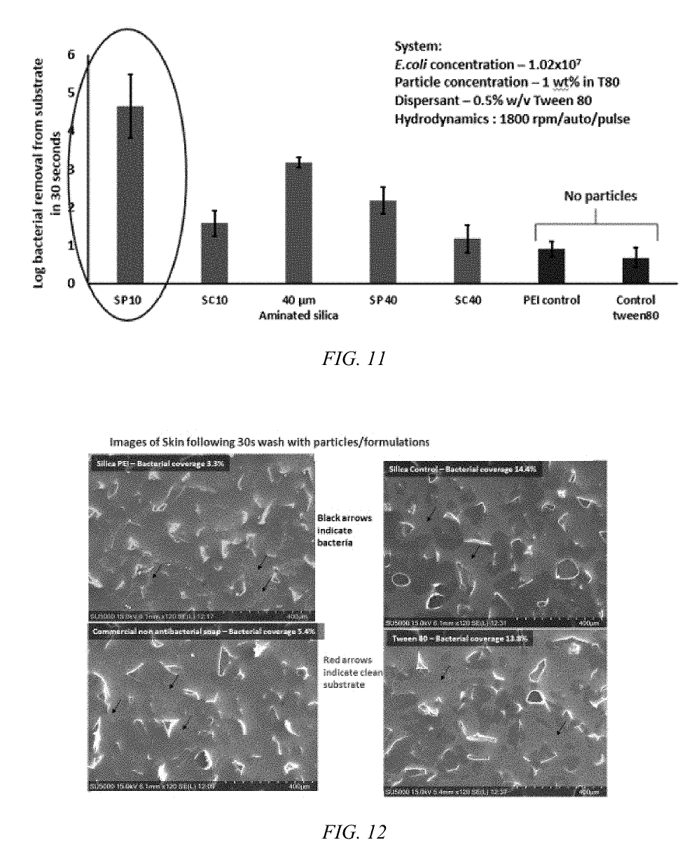

Exposure of E. coli to SP10 particles for 30 s results in a small loss of cell recovery (˜0.5 log) as seen from FIG. 9. This is attributed to bacterial aggregation on exposure to cationic particles and growth as a single colony on agar plates. Minimal inhibition or kill of E. coli (ATCC 25922) with branched PEI (10 kDa) has been established in another study and is, therefore, ruled out. SC10 particles, in contrast, demonstrated no attraction owing to charge similarity between particles and bacteria, both being negatively charged. In addition, minimal kill/removal with SC10 also demonstrates minimal mechanical cell disruption at the tested vortex speeds. Following treatment, modified and unmodified particles were recovered via centrifugation, dispersed in 1× Baclight™LIVE-DEAD® stain and imaged with a wide field fluorescence microscope. Fluorescence stain components SYTO9 and Propidium Iodide exhibit selective membrane penetration potential and exhibit amplified fluorescence when complexed with intracellular bacterial DNA. A significantly increased number of bacteria reside on modified SP10, as shown in FIG. 10 as compared to SC10, shown in FIG. 11 due to poor or no adhesion of bacteria on SC10. Additionally, significantly higher intensities of green fluorescence also indicate high cell viability with minimal cell membrane disruption. Red fluorescence (dye marker indicating membrane damage and cell death) in these images have been intentionally amplified to indicate most cells were viable following adsorption onto modified silica particles.

The removal from a plastic substrate was examined employing SP10 and an aminopropylsilane surface treated SC40 (aminated silica). Results are shown in FIG. 12, where bacteria was removed for 30 seconds using a particle suspension.

### Particle-Bacteria—Skin Interactions

Following particle-bacterial interactions in suspensions (driven by charge-charge interactions), particle interactions with bacteria adhered to a VITRO-SKIN® substrate were evaluated by investigating removal of E. coli from the artificial skin. Substrate containing 107 CFU E. coli cells were washed with 1 ml of 1 wt % SP10, SC10 0.5% Tween 80 without particles (control) at 1500 rpm (vortex speed) as per the protocol discussed previously.

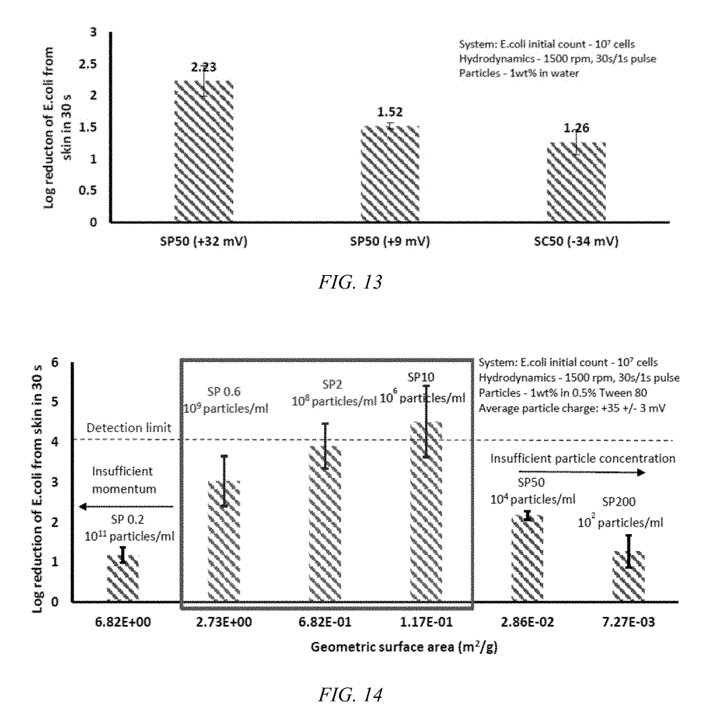

As illustrated in FIG. 13, SP10 particles exhibit enhanced removal of E. coli from substrate (˜4 logs) while in comparison SC10 (Control with particles) and Tween80 (SC10XP) without particles remove ˜1.3 logs of E. coli from the substrate under similar conditions. Such removal may be attributed to removal of unbound bacterial cells and drying stress related losses. Enhanced bacterial removal with cationic silica particles (SP10), on the other hand, indicated relatively stronger bacteria-particle interactions as compared to bacteria-substrate interactions. Additionally, low levels of removal with SC10 also indicates minimal effects of physical abrasion on removal of bacterial cells from substrates at chosen agitation speeds. This was further validated by washing skins at 4 rpm with control groups and determining removal of bacteria from skin (˜1.2 log reduction—data not shown). The skins for the experiments however, were deliberately not ‘gently rinsed’ to remove unbound cells as the authors agree with the discussion that these can introduce a number of artifacts about the initial concentration of bacterial cells as invoked in another review20. Another independent set of experiments with multiple washes (2 and 4) also demonstrated no additional bacterial removal (over the 1.8 log removal with control silica particles). Following 2 and 4 washes with silica control, washing with modified particles pushed bacterial reduction to >3 logs with SP 10 particles (supporting information Si). These experiments thus demonstrate the need strong bacteria particle interactions to overcome bacteria substrate interactions for enhanced removal based disinfection.

SEM images of substrate washed with various particles for disinfection of skin. Bacterial area coverage is an indicator of product efficacy. As shown in FIG. 14, the SP is superior to SC, Tween 80, and a commercial soap at removing bacteria in a 30 second wash.

Mechanism and Factors Affecting E. coli Removal from Artificial Skin Using SPs

Effect of Zeta Potential:

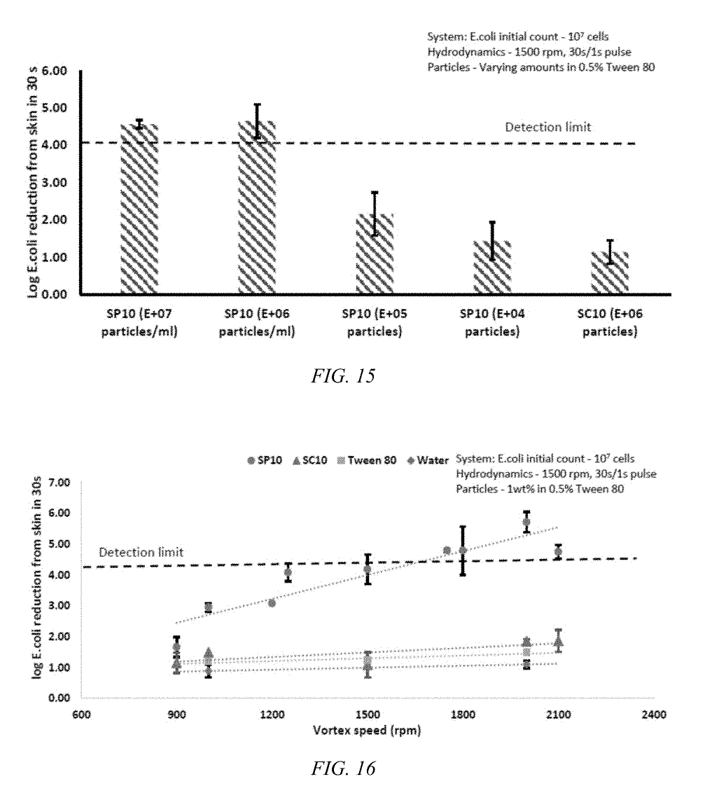

Impact of particle charge was investigated by assessing bacterial removal with particles of varying zeta potential with a fixed particle size in water to negate the effects of Tween 80, if any. SP50 particles with varying degree of functionalization, were measured to exhibit a zeta potential of +31.86+/−2.01, +8.84+/−0.99, −33.53+/−0.56 (10 mM KCl, pH 8.2) and were labelled SP50 (+32 mV), SP50 (+9 mV) and SC50 (˜34 mV), respectively. Particles with varying zeta potential were evaluated for their bacterial removal potential at a vortex speed of 1500 rpm. Results, as plotted in FIG. 15 indicate no improvement in bacterial reduction from skin with SC50 (˜34 mV) particles demonstrating very little interaction with adhered bacteria owing to similar charges. In comparison, a small but significant improvement in bacterial reduction from skin was observed with oppositely charged SP50 (+9 mV) particles and is attributed to relatively stronger bacteria-particle interactions between oppositely charged particles. The magnitude of interaction between SP50 (+9 mV) particles with the bacteria attached to the skin however, was noted as insufficient to achieve significant disinfection of the substrate and is reflected by high number of residual bacteria recovered from the skin following exposure to SP10 (+9 mV). Particle treatment with SP50 (+32 mV), on the other hand, exhibited significantly enhanced removal of bacteria from skin. This further reflects that strong bacteria-particle interactions capable of overcoming bacteria-substrate interactions are necessary for significant reduction in bacteria from substrates. Requirement of a minimum particle surface charge (interaction force) for strong enough interaction with bacteria to overcome bacterial adhesion to a substrate was therefore identified as a critical parameter necessary for enhanced removal of bacteria from the substrate. All tests were conducted at particle concentration of 1 wt %.

Effect of Particle Mass (Size):

To investigate the effect of particle mass, SPs les of various sizes and, therefore, various mass (material of constant density: mass α r3) but of similar zeta potential (˜+35 mV) were tested for skin disinfection efficacy, using the protocol described above, at a constant speed of 1500 rpm. Zeta potentials and naming scheme of the particles post modification, as listed in Table 2, above. For a fixed particle concentration of 1 wt %, variation in particle size affects both particle number density (total available surface area) and the mass per particle.

A frame of reference with respect to SP10 was therefore imposed to de-convolute contributions of particle mass from the effects of particle number density. Additionally, highly positive zeta potential values at all particle sizes tested ensured almost equally strong bacteria-particle interactions. Results from FIG. 16 indicate reduction of E. coli from skin to below detection limits using SP10 particles (+35 mV) at a particle number density of −10⁶ particles per ml. For extremely small particle sizes however (200 and 600 nm), reduction in removal efficacy, despite increase in particle number density (˜10⁹-10¹¹ per ml) and similar zeta potentials, indicated insufficient momentum transfer at 1500 rpm owing to relatively small mass of the particle-bacteria entity thereby imparting smaller momentum transfer than required for detachment of the bacteria from the skin substrate. Conversely, at larger particle sizes (SP50 and SP200) sufficient momentum transfer seem to exist at 1500 rpm, In this case reduction in removal efficacy can be attributed to reduction in particle number density (10²-10⁴ per ml) and, therefore, the total geometric surface area available for particle-bacterial interaction. Enhanced performance with SP2 and SP10, as shown in FIG. 16, can be attributed to availability of optimal surface area at 1 wt % while also possessing enough mass necessary for momentum transfer and removal of cells from the substrate.

Effect of Particle Concentration/Loading:

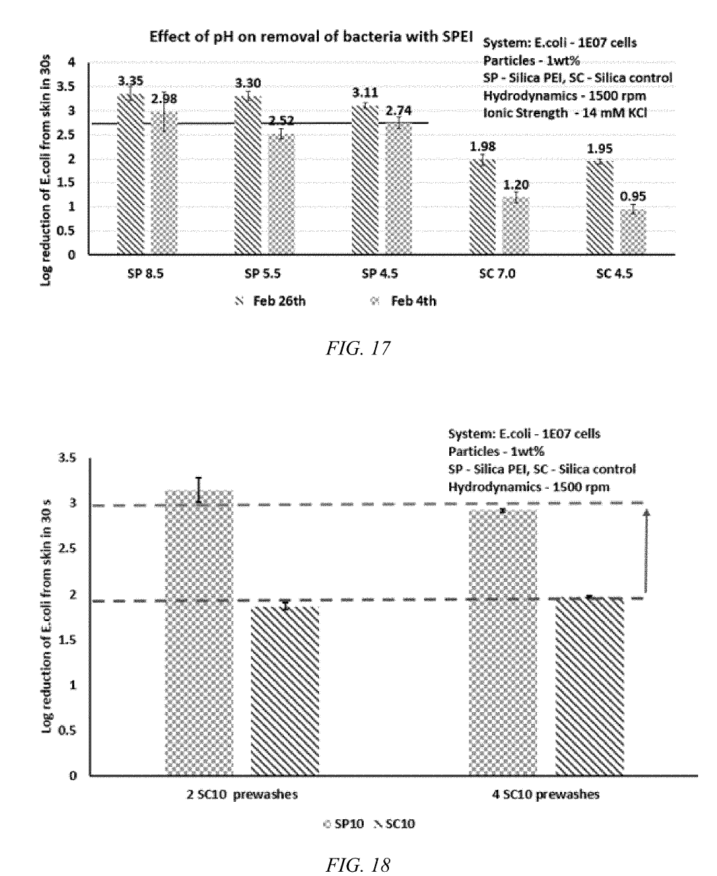

SP10 particles examined at constant size, particle velocity (1500 rpm), and zeta potential (˜+35 my) were used at different particle loading/concentration to isolate the effect of particle concentration for optimal removal of microbes from surface. Artificial skin with bacteria were washed with 1 ml suspensions of SP10 (10 μm PEI silica) at 0.01%, 0.1% and 1 wt % concentrations. FIG. 17 indicates a threshold particle concentration of between 105 and 106 particles/107 bacterial cells, below which a significant drop off in microbial removal was observed.

Effect of Particle Velocity:

The effect of particle velocity, removal of E. coli from a substrate was evaluated using SP10, SC10 (1 wt %) and particle-less controls at various vortex speeds. It is assumed that for a particle of constant size and medium of constant viscosity, the velocity of the particle at a fixed distance near skin increases proportionally with the speed of the vortex mixer. As can be seen in FIG. 18, bacterial removal of ˜1 log is observed when agitated at very low speeds of 1000 rpm with modified particles and controls, indicating the removal of unbound or loosely bound bacteria from the substrate. For the range of tested agitation speeds, particle-less control groups Tween 80 and water and SC10 at 1 wt % show minimal removal of bacteria from the substrate over the loosely bound bacteria. Extremely low efficiencies of bacterial removal with the tested controls indicate negligible contributions from liquid shear in bacterial removal from substrates. SP10 particles show a significant increase in removal of E. coli with increasing vortex speeds and particle velocity, indicating threshold particle velocity of about 1300 rpm must be achieved to overcome microbial adhesion to skin.

Effect of pH:

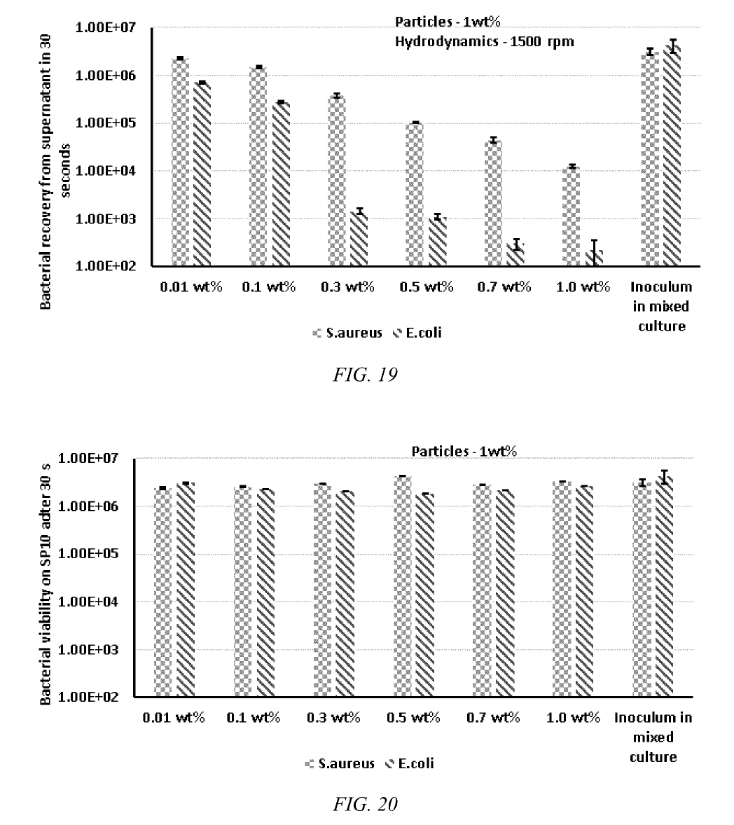

The effect of pH of the suspension used for removal of E. coli from a substrate was evaluated using SP10 and SC10 at 1 wt %. As shown in FIG. 19, the particles were found to be stale at all pH's tested. A common ionic strength was employed. For the range of tested agitation speed was constant. Variation in intensity of removal varied for data taken on two different days but the trend was consistent with pH. The effectiveness of the SP10 was good over the entire pH range tested and the effectiveness of SC10 was significantly poorer.

Multiple Washings:

Although SC10 displayed little reduction in a single wash, multiple washings indicated some removal, as after two washes with SC10 a third wash showed less removal of E. coli than after a fifth was, as indicated in FIG. 20. The effectiveness of SP10 over SC10 remains apparent.

### Selectivity to Bacteria

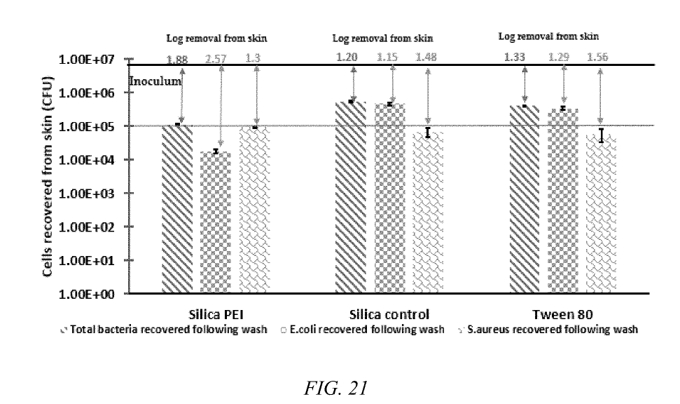

Selective flocculation of E. coli over S. aureus from suspension was observed for charged SPs based on charge, where a 0.3 wt % of SPs appear to be optimal for this system under operating conditions. Cells recovered show very good viability and vary from 60% to 99% of recovered cells. The SPs do not result in kill of the bacteria in either case, as indicated in FIG. 21. Selectivity is imparted on cells that are removed from a substrate based on the relative adhesion strength between bacteria, SPs, and the substrate, as shown in FIG. 22. This indicates that particles can be designed to selectively remove cells of interest from a substrate. FIG. 23 shows that E. coli is selectively removed over S. aureus from an artificial skin substrate.

It should be understood that the examples and embodiments described herein are for illustrative purposes only and that various modifications or changes in light thereof will be suggested to persons skilled in the art and are to be included within the spirit and purview of this application.

We claim:

1. A suspension for removing or repelling microbes from a surface, comprising a plurality of modified particles (MPs), where the MPs comprise microparticles or nanoparticles of a metal, alloy, metal oxide, graphite, organic polymer, or any combination thereof, where upon the surfaces of the microparticles or nanoparticles comprises a coating or a covalently bonded functionality, and a liquid for suspension of the MPs.

2. The suspension for removing or repelling microbes from a surface according to claim 1, wherein the MPs comprise coated or surface reacted metals, alloys, metal oxides or any combination thereof.

3. The suspension for removing or repelling microbes from a surface according to claim 2, wherein the metal is a non-toxic stable solid.

4. The suspension for removing or repelling microbes from a surface according to claim 2, wherein the metal oxide is aluminum oxide, barium oxide, calcium oxide, cerium oxide, chromium oxide, cobalt oxide, copper oxide, gallium oxide, germanium oxide, iron oxide, lead oxide, magnesium oxide, manganese oxide, molybdenum oxide, nickel oxide, ruthenium oxide, silicon oxide, silver oxide, tin oxide, titanium oxide, tungsten oxide, zinc oxide, or any combination thereof.

5. The suspension for removing or repelling microbes from a surface according to claim 1, wherein the MPs comprise organic particles.

6. The suspension for removing or repelling microbes from a surface according to claim 5, wherein the organic particles are graphite, natural or synthetic polymer, natural or synthetic copolymer, natural or synthetic gels, natural or synthetic resins, or any combination thereof.

7. The suspension for removing or repelling microbes from a surface according to claim 6, wherein the synthetic polymer is polyethylene, polypropylene, polybutylene, polystyrene, polyvinyl chloride, polyamide, polyurethane, polyester, polyimide, polyethersulfone, polycarbonate, polyacrylate, polymethacrylate, polybutadiene, polyvinylmethylether, polytetrafluoroethylene, polyisoprene, polyacrylonitrile, polyethyleneterephthalate, polyacetal, polybutyleneterephthalate, polyetheretherketone, polyamideimide, polyetherimide, thermoset silicone, acrylonitrile-butadiene-styrene, or any combination thereof.

8. The suspension for removing or repelling microbes from a surface according to claim 6, wherein the natural polymer is cellulose or chitin.

9. The suspension for removing or repelling microbes from a surface according to claim 1, wherein the coating comprises a cationic polymer, an anionic polymer, or a nonionic polymer.

10. The suspension for removing or repelling microbes from a surface according to claim 1, wherein the coating comprises polyethyleneimine (PEI), branched polyethyleneimine (bPEI), 2-(dimethylamino)ethyl methacrylate (DMAEMA), poly(amidoamine) (PAMAM), chitosan, Bufloc 535, Nalco 7607, Reten 201, Cypro 515, Bufloc 5554, Busperse 5030, biological cationic polymers, modified chitosan, cationic liposomes, polyacrylamides, dicyandiamideformaldehyde, diallydimethylammonium chloride, epichlorohydrinamine, octadecyldimethoxylsilpropy-ammonium chloride, octadecyldimethyltrimethoxylsilpropyl-ammonium chloride, modified starch, 1-methyl-2-Noroleyl-3-oleyl-amidoethylimidazoline methylsulfate, 1-ethyl-2-Noroleyl-3-oleyl-amidoethylimidazoline ethylsulfate, amodimethicone, trimethylsilylmodimethicone, polyquaternium-2, polyquaternium-4, polyquaternium-5, polyquaternium-7, polyquaternium-8, polyquaternium-9, polyquaternium-10, polyquaternium-11, polyquaternium-12, polyquaternium-13, polyquaternium-14, polyquaternium-15, polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-32, polyquaternium-33, polyquaternium-34, polyquaternium-35, polyquaternium-36, polyquaternium-37, polyquaternium-39, polysilicone-1, polysilicone-2, and mixtures and combinations thereof.

11. The suspension for removing or repelling microbes from a surface according to claim 1, wherein the covalently bound functionality comprises a surface reacted product from aminopropyltriethoxy silane or other amino comprising silane or a surface grafted cationic polymer.

12. The suspension for removing or repelling microbes from a surface according to claim 1, wherein the coating comprises a pluronic.

13. The suspension for removing or repelling microbes from a surface according to claim 1, wherein the liquid for suspending the MPs comprises water.

14. The suspension for removing or repelling microbes from a surface according to claim 1, wherein the liquid further comprises a surfactant.

15. The suspension for removing or repelling microbes from a surface according to claim 1, wherein the MPs further comprise a bound antibody.

16. A method of removing microbes from a surface, comprising contacting a suspension comprising a plurality of MPs according to claim 1, wherein the coating or a covalently bonded functionality of the MPs provide a cationic surface having a positive Zeta potential greater than the positive Zeta potential of the surface.

17. The method according to claim 16, wherein the MPs comprise silica microparticles and/or polystyrene microparticles.

18. The method according to claim 16, wherein the coating comprises polyethylene imine (PEI) or chitosan.

19. The method according to claim 16, wherein the liquid for suspending the MPs is an aqueous solution of a surfactant.

20. The method according to claim 16, wherein contacting comprises washing.

21. The method according to claim 16, wherein the surface is skin.

22. A method of repelling microbes from a surface, comprising contacting a suspension comprising a plurality of MPs according to claim 1, wherein the coating or a covalently bonded functionality of the MPs provide an anionic surface having a negative Zeta potential greater than or equal to the negative Zeta potential of the microbe.

23. The method according to claim 22, wherein the MPs comprise silica microparticles and/or polystyrene microparticles.

24. The method according to claim 22, wherein the coating is an anionic polymer or comprises the surface reacted product from a carboxylic acid comprising silane or a surface grafted anionic polymer.

25. The method according to claim 22, further comprising removing at least a portion of liquid for suspension of the MPs contacted with the surface.
